(19) United States
(12) Patent Application Publication
(10) Pub. No.: US 2025/0265449 A1
(43) Pub. Date: Aug. 21, 2025

(54) SYSTEMS AND METHODS FOR GENERATING SPORTS TRACKING DATA USING MULTIMODAL GENERATIVE MODELS

(71) Applicant: STATS LLC, Chicago, IL (US)

(72) Inventors: Patrick Joseph LUCEY, Chicago, IL (US); Harry HUGHES, Brisbane (AU); Michael John HORTON, Wellington (NZ); Felix WEI, Melbourne (AU); Christian MARKO, Graz (AT)

(73) Assignee: STATS LLC, Chicago, IL (US)

(21) Appl. No.: 19/051,366

(22) Filed: Feb. 12, 2025

Related U.S. Application Data
(60) Provisional application No. 63/554,429, filed on Feb. 16, 2024.

(51) Int. Cl. G06N 3/0455; G06F 40/279

(52) U.S. Cl. CPC G06N 3/0455; G06F 40/279

(57) ABSTRACT

Disclosed techniques relate to using machine learning for sports applications. In an example, a method for generating sports tracking data using multimodal generative models may include receiving one or more inputs by a user. The input may be related to a description. The method may further include extracting metadata items relating to the description. The method may further include mapping the metadata items to at least one or more event streams. The method may further include receiving content items relating to the event streams. The event streams contain content items that are outputted by a multimodal sports learning language model (LLM). The method may further include transmitting the content items to a user device for display.

### CROSS-REFERENCE TO RELATED APPLICATIONS

This application claims the benefit of priority to U.S. Provisional Application No. 63/554,429, filed Feb. 16, 2024, which is incorporated by reference in its entirety.

### TECHNICAL FIELD

Various embodiments of the present disclosure relate generally to machine-learning-based techniques for generating sports event data and, more particularly, to systems and methods for extracting and processing user inputs as they relate to sports event data.

### INTRODUCTION

Generative AI applications that exist today focus on the task of using text to generate an image, video, or audio (or a combination of video and audio). This is done by using generative AI techniques to learn the mapping from one modality to the other. This technology can also be used for its conversational aspect, where refinements on the initial text description can occur to improve the output.

Unless otherwise indicated herein, the materials described in this section are not prior art to the claims in this application and are not admitted to be prior art, or suggestions of the prior art, by inclusion in this section.

### SUMMARY OF THE INVENTION

In some aspects, the techniques described herein relate to a method for generating sports tracking data using multimodal generative models, the method including: receiving, by a computing system, one or more inputs by a user, wherein the one or more inputs include at least a description; extracting, by the computing system, one or more metadata items relating to the description; mapping, by the computing system, the one or more metadata items to at least one or more event streams; receiving, by the computing system, one or more content items relating to the at least one or more event streams, wherein the one or more content items relating to the at least one or more event streams is output by a multimodal sports learning language model (LLM); and transmitting, by the computing system, the one or more content items to a user device for display.

In some aspects, the techniques described herein relate to a system for generating sports tracking data using multimodal generative models, the system including: a memory storing instructions: a generative machine learning model trained to generate sports tracking data; a processor operatively connected to the memory and configured to execute instructions to perform: receive one or more inputs by a user, wherein the one or more inputs include at least a description; extract one or more metadata items relating to the description; map the one or more metadata items to at least one or more event streams; receive one or more content items relating to the at least one or more event streams, wherein the one or more content items relating to the at least one or more event streams is outputted by a multimodal sports learning language model (LLM); and transmit the one or more content items to a user device for display.

In some aspects, the techniques described herein relate to a non-transitory computer readable medium configured to store processor-readable instructions, wherein when executed by a processor, the instructions perform operations including: receiving, by a client device, one or more user inputs, wherein the one or more user inputs include at least a description; extracting one or more metadata items relating to the description; mapping the one or more metadata items to at least one or more event streams; receiving one or more content items relating to the at least one or more event streams, wherein the one or more content items relating to the at least one or more event streams is outputted by a multimodal sports learning language model (LLM); and transmitting the one or more content items to a user device for display.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 depicts a block diagram illustrating a computing environment, according to example embodiments.

FIG. 2A depicts example screenshots of the sports tracking data being used in conjunction with raw broadcasting tracking data, according to example embodiments.

FIG. 2B depicts an example flowchart for generating tracking and/or event data, according to example embodiments.

FIGS. 3-4 depicts example user inputs scenarios for the machine-learning model to generate sports tracking data, according to example embodiments.

FIGS. 5-6 depicts flow diagrams of an exemplary method for using the machine-learning model to generate sports tracking data, according to example embodiments.

FIG. 7 depicts an example use of generating sports tracking data within an Augmented Reality/Virtual Reality (AR/VR) and Mixed reality application, according to example embodiments.

FIG. 8 depicts another example use of generating sports tracking data, according to example embodiments.

FIG. 9 depicts a flow diagram for training a machine-learning model, according to example embodiments.

FIG. 10A depicts a block diagram illustrating a computing device, according to example embodiments.

FIG. 10B depicts another block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Various aspects of the present disclosure relate generally to machine-learning for sports applications, in particular various aspects relate to the systems and methods for refinement of generating sports tracking data using user inputs.

According to aspects disclosed herein, a multimodal sports learning language model (LLM) may receive text, audio, video, or drawings as inputted information from a user or computing system. The multimodal sports LLM may use preprocessed event streams to map corresponding metadata to the input information. This information may be used in the multimodal sports LLM to determine generated sports tracking data for output. The outputted information may be in the form of visualizations, retrieval systems, analyses, audio and/or textual commentary or a combination thereof. The outputted information may be event and/or tracking data that is generated by the multimodal sports LLM and/or historical event and/or tracking data that is associated with the user input query information.

The following non-limiting example is introduced for discussion purposes. In the example, a system receives user input for including a query related to one or more sporting events. The system identifies and accesses relevant database records from a database. The database records can include sports-related data associated with the sporting event(s) such as player, team, and/or league related information. The system determines intentional and contextual information from the query. This information is then mapped to database records to generate sports tracking data based on the received query. The system can format and output the generated sports tracking data to the client device.

Technical advantages of the disclosed techniques include improvements to machine learning. For instance, certain aspects relate to determining intentional and contextual information from a user input that improve the performance, accuracy, and results of information to be mapped to sports-related data. In doing so, disclosed techniques provide improvements relative to existing solutions.

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.” As used herein, the singular forms “a,” “an,” and “the” include plural reference unless the context dictates otherwise.

Other embodiments of the disclosure will be apparent to those skilled in the art from consideration of the specification and practice of the invention disclosed herein. It is intended that the specification and examples be considered as exemplary only.

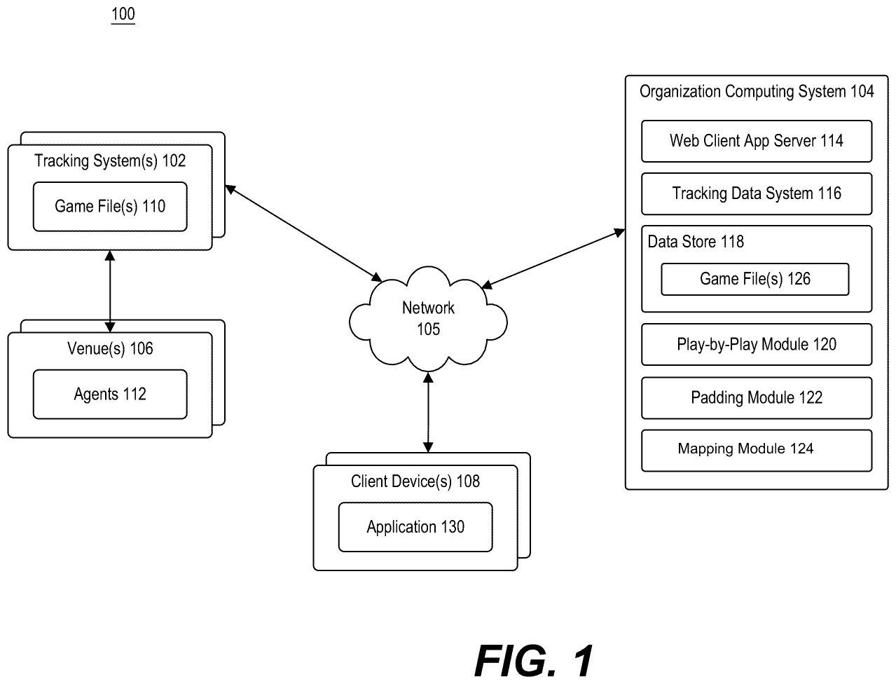

FIG. 1 is a block diagram illustrating a computing environment 100, according to example embodiments. Computing environment 100 may include tracking system 102 (e.g., positioned at or in communication with one or more components positioned at venue 106), organization computing system 104, and one or more client devices 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106 and/or may be in communication (e.g., electronic communication, wireless communication, wired communication, etc.) with components located at venue 106. For example, venue 106 may be configured to host a sporting event that includes one or more agents 112. Tracking system 102 may be configured to capture the motions of one or more agents (e.g., players) on the playing surface, as well as one or more other agents (e.g., objects) of relevance (e.g., ball, puck, referees, etc.). In some embodiments, tracking system 102 may be an optically-based system using, for example, a plurality of fixed cameras, movable cameras, one or more panoramic cameras, etc. For example, a system of six calibrated cameras (e.g., fixed cameras), which project three-dimensional locations of players and a ball onto a two-dimensional overhead view of the playing surface may be used. In another example, a mix of stationary and non-stationary cameras may be used to capture motions of all agents on the playing surface as well as one or more objects or relevance. Utilization of such a tracking system (e.g., tracking system 102) may result in many different camera views of the playing surface (e.g., high sideline view, free-throw line view, huddle view, face-off view, end zone view, etc.).

In some embodiments, tracking system 102 may be used for a broadcast feed of a given match. For example, tracking system 102 may be used to generate game files 110 to facilitate a broadcast feed of a given match. In such embodiments, each frame of the broadcast feed may be stored in a game file 110. A broadcast feed may be a feed that is formatted to be broadcast over one or more channels (e.g., broadcast channels, internet based channels, etc.). A game file 110 may be converted from a first format (e.g., a format output by the one or more cameras or a different format than the format output by the one or more cameras) and may be converted into a second format (e.g., for broadcast transmission).

In some embodiments, game file 110 may further be augmented with other event information corresponding to event data, such as, but not limited to, game event information (pass, made shot, turnover, etc.) and context information (current score, time remaining, etc.). Event data may be automatically identified using a machine learning trained to receive, as an input, a game file 110 or a subset thereof and output game information and/or context information based on the input. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, and/or the like and may include tagged and/or untagged data.

Tracking system 102 may be configured to communicate with organization computing system 104 via network 105. For example, tracking system 102 may be configured to provide organization computing system 104 with a broadcast stream of a game or event in real-time or near real-time via network 105. As an example, tracking system 102 may provide one or more game files 110 in a first format (e.g., corresponding to a format based on the components of tracking system 102). Alternatively, or in addition, tracking system 102 or organization computing system 104 may convert the broadcast stream (e.g., game files 110) into a second format, from the first format. The second format may be based on the organization computing system 104. For example, the second format may be a format associated with data store 118, discussed further herein.

Organization computing system 104 may be configured to process the broadcast stream of the game. Organization computing system 104 may include at least a web client application server 114, tracking data system 116, data store 118, play-by-play module 120, padding module 122, and/or mapping module 124. Each of tracking data system 116, play-by-play module 120, padding module 122, and mapping module 124 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of the instructions.

Tracking data system 116 may be configured to receive broadcast data from tracking system 102 and generate tracking data from the broadcast data. In some embodiments, tracking data system 116 may apply an artificial intelligence and/or computer vision system configured to derive player-tracking data from broadcast video feeds.

To generate the tracking data from the broadcast data, tracking data system 116 may, for example, map pixels corresponding to each player and ball to dots and may transform the dots to a semantically meaningful event layer, which may be used to describe player attributes. For example, tracking data system 116 may be configured to ingest broadcast video received from tracking system 102. In some embodiments, tracking data system 116 may further categorize each frame of the broadcast video into trackable and non-trackable clips. In some embodiments, tracking data system 116 may further calibrate the moving camera based on the trackable and non-trackable clips. In some embodiments, tracking data system 116 may further detect players within each frame using skeleton tracking. In some embodiments, tracking data system 116 may further track and re-identify players over time. For example, tracking data system 116 may re-identify players who are not within a line of sight of a camera during a given frame. In some embodiments, tracking data system 116 may further detect and track an object across a plurality of frames. In some embodiments, tracking data system 116 may further utilize optical character recognition techniques. For example, tracking data system 116 may utilize optical character recognition techniques to extract score information and time remaining information from a digital scoreboard of each frame.

Such techniques assist in tracking data system 116 generating tracking data from the broadcast feed (e.g., broadcast video data). For example, tracking data system 116 may perform such processes to generate tracking data across thousands of possessions and/or broadcast frames. In addition to such process, organization computing system 104 may go beyond the generation of tracking data from broadcast video data. Instead, to provide descriptive analytics, as well as a useful feature representation for mapping module 124, organization computing system 104 may be configured to map the tracking data to a semantic layer (e.g., events).

Tracking data system 116 may be implemented using a machine learning model. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, historical or simulated feature representations, and/or the like and may include tagged and/or untagged data. The tagged data may include position information, movement information, object information, trends, agent identifiers, agent re-identifiers, etc.

Play-by-play module 120 may be configured to receive play-by-play data from one or more third party systems. For example, play-by-play module 120 may receive a play-by-play feed corresponding to the broadcast video data. In some embodiments, the play-by-play data may be representative of human generated data based on events occurring within the game. Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, play-by-play module 120 may utilize machine learning outputs and/or manually annotated data that may reflect the referee's ultimate adjudication. Such data may be referred to as the play-by-play feed.

To help identify events within the generated tracking data, tracking data system 116 may merge or align the play-by-play data with the raw generated tracking data (which may include the game and time fields). Tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, tracking data system 116 may be configured to perform various operations on the aligned tracking system. For example, tracking data system 116 may use the play-by-play data to refine the player and ball positions and precise frame of the end of possession events (e.g., shot/rebound location). In some embodiments, tracking data system 116 may further be configured to detect events, automatically, from the tracking data. In some embodiments, tracking data system 116 may further be configured to enhance the events with contextual information.

For automatic event detection, tracking data system 116 may include a neural network system trained to detect/refine various events in a sequential manner. For example, tracking data system 116 may include an actor-action attention neural network system to detect/refine one or more of: shots, scores, points, rebounds, passes, dribbles, penalties, fouls, and/or possessions. Tracking data system 116 may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, the specialist event detectors may use a neural network approach or another machine learning classifier (e.g., random decision forest, SVM, logistic regression etc.).

While mapping the tracking data to events enables a player representation to be captured, to further build out the best possible player representation, tracking data system 116 may generate contextual information to enhance the detected events. Exemplary contextual information may include defensive matchup information (e.g., who is guarding who at each frame, defensive formations), as well as other defensive information such as coverages for ball-screens or presses.

In some embodiments, to measure influence, tracking data system 116 may use a measure referred to as an “influence score.” The influences score may capture the influence a player may have on each other player on an opposing team on a scale of 0-100. In some embodiments, the value for the influence score may be based on sport principles, such as, but not limited to, proximity to player, distance from scoring object (e.g., basket, goal, boundary, etc.), gap closure rate, passing lanes, lanes to the scoring object, and the like.

Padding module 122 may be configured to create new player representations using mean-regression to reduce random noise in the features. For example, one of the profound challenges of modeling using potentially only limited games (e.g., 20-30 games) of data per player may be the high variance of low frequency events seen in the tracking data. Therefore, padding module 122 may be configured to utilize a padding method, which may be a weighted average between the observed values and sample mean.

Accordingly, for each player, tracking data system 116, play-by-play module 120, and padding module 122 may work in conjunction to generate a raw data set and a padded data set for each player.

Mapping module 124 may be configured or trained to generate a connection and/or association with prompts of a multimodal sports LLM and user inputs (e.g., audio, speech, drawings, video, etc.). For example, mapping module 124 may be configured to receive a user input (e.g., audio/speech) requesting information relating to a play within a specific match (e.g., goal scored by Manchester United against Liverpool). Mapping module 124 may generate one or more connections and/or associations with the user input and the event stream (e.g., match between Manchester United against Liverpool). Based on the generated connections, mapping module 124 may be configured to determine event data associated with the event stream and the user input. The mapping module 124 may output one or more graphics, text, audio, or a combination thereof based on the determined connections and/or associations with the user input.

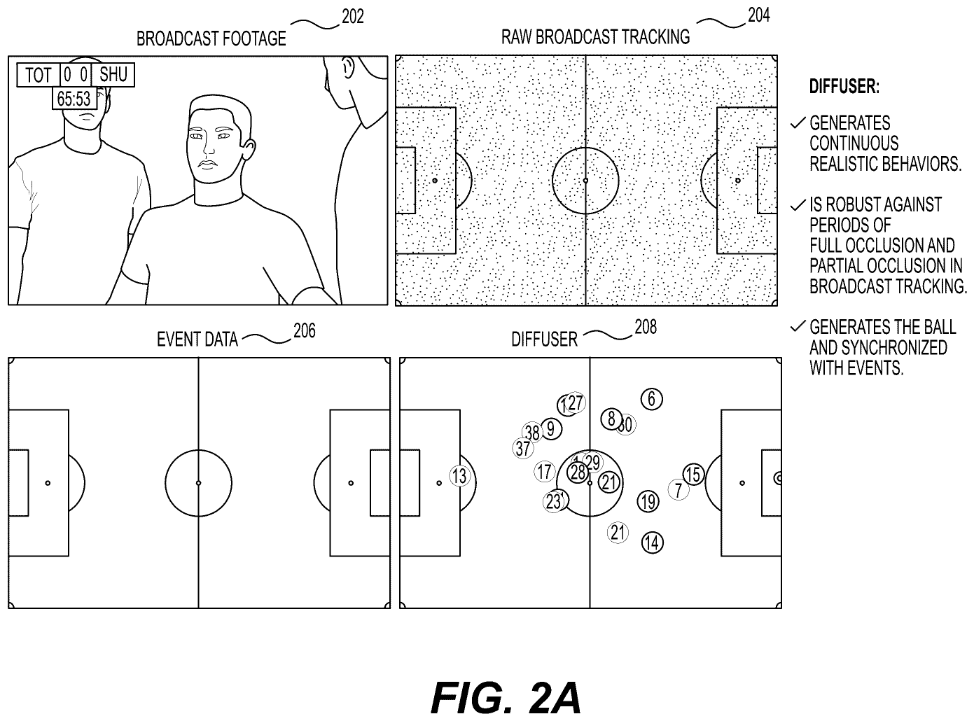

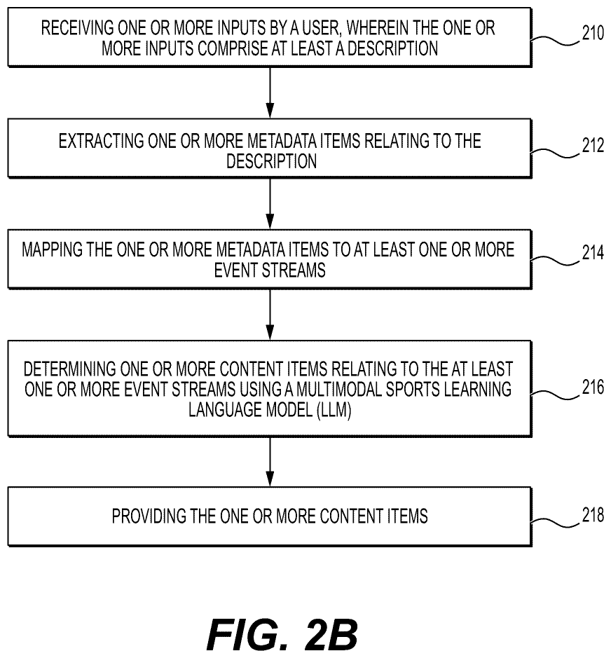

In some embodiments, mapping module 124 may include a separate mapping model tuned for each input type (e.g., audio, text, drawing, video, etc.). Given that each input is very different from each other, there may be times that a single mapping model may have trouble determining connections and/or associations. In such scenarios, one or more individual mapping models may be employed for a single user input. For example, upon receiving a user input (e.g., speech and drawing), mapping module 125 may utilize one or more mapping models for each input type received. The one or more mapping models may determine one or more connections and/or associations from the received inputs. Based on the determined one or more connections, mapping module 124 may output one or more graphics and texts corresponding to the user inputs. Mapping module 124 is discussed further in conjunction with figures discussed below (e.g., FIGS. 2-6).

Data store 118 may be configured to store one or more game files 126. Each game file 126 may include video data of a given match. For example, the video data may correspond to a plurality of video frames captured by tracking system 102, the tracking data derived from the broadcast video as generated by tracking data system 116, play-by-play data, enriched data, and/or padded training data. Game files 126 may be based, for example, on game files 110 as discussed herein. Game files 126 may be in a different format than game files 110. For example, a first format of game files 110 or a subset thereof may be transformed into a second format of game files 126. The transformation may be performed automatically based on the type and/or content of the first format and the type and/or content of the second format.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 130. Application 130 may be representative of a web browser that allows access to a website or a stand-alone application. Client device 108 may access application 130 to access one or more functionalities of organization computing system 104. Client device 108 may communicate over network 105 to request a webpage, for example, from web client application server 114 of organization computing system 104. For example, client device 108 may be configured to execute application 130 to access one or more determined connections and/or associations based on a user input generated by the mapping module 124. The content that is displayed to client device 108 may be transmitted from web client application server 114 to client device 108, and subsequently processed by application 130 for display through a graphical user interface (GUI) of client device 108.

### Prediction Engine General Description

A prediction engine (e.g., which may be part of a tracking data system) may be configured to predict an underlying formation of a team. Mathematically, the goal of a role-alignment procedure may be to find the transformation A: {U₁, U₂, . . . , Uₙ}×M→[R₁, R₂, . . . , R_{K}], which may map the unstructured set U of N player trajectories to an ordered set (e.g., a vector) of K role-trajectories R. Each player trajectory itself may be an ordered set of positions Uₙ=[x_{s,n}]ₛ₌₁^{S} for an agent n∈[1, N] and a frame s∈[1, S]. In some embodiments, M may represent the optimal permutation matrix that enables such an ordering. The goal of the prediction engine may be to find the most probable set of [symbol] of two-dimensional (2D) probability density functions:

$$ℱ *= arg {max}_{ℱ} P ( ℱ \vert R )$$

$$P ( x ) = {\sum }_{n = 1}^{N} P ( x \vert n ) P ( n ) = \frac{1}{N} {\sum }_{n = 1}^{N} {P}_{n} ( x )$$

In some embodiments, this equation may be transformed into one of entropy minimization where the goal is to reduce (e.g., minimize) the overlap (e.g., the KL-Divergence) between each role. As such, in some embodiments, the final optimization equation in terms of total entropy H may become:

$$ℱ *= arg {max}_{ℱ} {\sum }_{n = 1}^{N} H ( x \vert n )$$

The prediction engine may include a formation discovery module, a role assignment module, a template module, and/or the like each corresponding to a distinct phase of the prediction process. The formation discovery module may be configured to learn the distributions which maximize the likelihood of the data. The role assignment module may be configured to map each player position to a “role” distribution in each frame. Once the data has been aligned, the template module may be configured to map each learned formation a formation cluster template.

An organization computing system may receive tracking data and/or event data for a plurality of events across a plurality of seasons or across a match. For each event, the pre-processing agent may divide the event into a plurality of segments based on the event information. In some embodiments, the pre-processing agent may divide the event into a plurality of segments based on various events that may occur throughout the game. For example, the pre-processing agent may divide the event into a plurality of segments based on one or more events that include, but may not be limited to, red cards, ejections, technical fouls, flagrant fouls, player disqualifications, substitutions, halves, periods, quarters, overtime, and the like. Generally, each segment of a plurality of segments associated with an event may include an interval of a requisite duration (e.g., at least one minute of play, at least two minutes of play, etc.). Such requisite duration may allow an organization computing system to detect a team's formation.

Each segment may include a set of tracking data associated therewith. The player tracking data may be captured by tracking system, which may be configured to record the (x, y) positions of the players at a high frame rate (e.g., 10 Hz). In some embodiments, the player tracking data may further include single-frame event-labels (e.g., pass, shot, cross) in each frame of player tracking data. These frames may be referred to as “event frames.” As shown, the initial player tracking data may be represented as a set U of N player trajectories. Each player trajectory itself may be an ordered set of positions Uₙ=[x_{s,n}]ₛ₌₁^{S} for an agent n∈[1, N] and a frame s∈[1, S].

In some embodiments, the pre-processing agent may normalize the raw position data of the players. For example, the pre-processing agent may normalize the raw position data of the players in each segment so that all teams in the player tracking data are attacking from left to right and have zero mean in each frame. Such normalization may result in the removal of translational effects from the data. This may yield the set U′={U₁′, U₂′, . . . , Uₙ′}.

In some embodiments, the pre-processing agent may initialize cluster centers of the normalized data set for formation discovery with the average player positions. For example, average player positions may be represented by the set μ₀={μ₁, μ₂, . . . , μ₃}. The pre-processing agent may take the average position of each player in the normalized data and may initialize the normalized data based on the average player positions. Such initialization of the normalized data based on average player position may act as initial roles for each player to minimize data variance.

An organization computing system may learn a formation template from the tracking data for each segment. For example, the formation discovery module may learn the distributions which maximize the likelihood of the data. The formation discovery module may structure the initialized data into a single (SN)×d vector, where S may represent the total number of frames, N may represent the total number of agents (e.g., ten outfielders in the case of soccer, five players in the case of basketball, fifteen players in the case of rugby, etc.) and d may represent the dimensionality of the data (e.g., d=2).

The formation discovery module may then initiate a formation discovery algorithm. For example, the formation discovery module may initialize a K-means algorithm using the player average positions and execute to convergence. Executing the K-means algorithm to convergence produces better results than conventional approaches of running a fixed number of iterations.

The formation discovery module may then initialize a Gaussian Mixture Model (GMM) using cluster centers of the last iteration of the K-means algorithm. By parametrizing the distribution as a mixture of K Gaussians (with K being equal to the number of “roles,” which is usually also equal to N, the number of players), the formation discovery module may be able to identify an optimal formation that maximizes the likelihood of the data x. In other words, GMM may be configured to identify [symbol] ={P₁, P₂, . . . , P_{K}}, where [symbol] may represent the optimal formation that maximizes the likelihood of the data x. Therefore, instead of stopping the process after the last iteration of the K-means algorithm, the formation discovery module may use GMM clustering, as the ellipse may better capture the shape of each player role compared to only a K-means clustering technique, which captures the spherical nature of each role's data cloud.

Further, GMMs are known to suffer from component collapse and become trapped in pathological solutions. Such collapse may result in non-sensible clustering, e.g., non-sensical outputs that may not be utilized. To combat this, the formation discovery module may be configured to monitor eigenvalues (λᵢ) of each of the components or parameters of the GMM throughout the expectation maximization process. If the formation discovery module determines that the eigenvalue ratio of any component becomes too large or too small, the next iteration may run a Soft K-Means (e.g., a mixture of Gaussians with spherical covariance) update instead of the full-covariance update. Such process may be performed to ensure that the eventual clustering output is sensible. For example, the formation discovery module may monitor how the parameters of the GMM are converging; if the parameters of the GMM are erratic (e.g., “out of control”), the formation discovery module may identify such erratic behavior and then slowly return the parameters back within the solution space using a soft K-means update.

### Hash-Table/Playbook Learning

For retrieval tasks using large amounts of data, an embodiment of the system uses a hash-table is required by grouping similar plays together, such that when a query is made, only the “most-likely” candidates are retrieved. Comparisons can then be made locally amongst the candidates and each play in these groups are ranked in order of most similar. Previous systems attempted clustering plays into similar groups by using only one attribute, such as the trajectory of the ball. However, the semantics of a play are more accurately captured by using additional information, such as information about the players (e.g., identity, trajectory, etc.) and events (pass, dribble, shot, etc.), as well as contextual information (e.g., if team is winning or losing, how much time remaining, etc.). Thus, embodiments of the present system utilize information regarding the trajectories of the ball and the players, as well as game events and contexts, to create a hash-table, effectively learning a “playbook” of representative plays for a team or player's behavior. The playbook is learned by choosing a classification metric that is indicative of interesting or discriminative plays. Suitable classification metrics may include predicting the probability of scoring in soccer or basketball (e.g., expected point value (“EPV”), or expected goal value (“EGV”). Other predicted values can also be chosen for performance variables, such as probability of making a pass, probability of shooting, probability of moving in a certain direction/trajectory, or the probability of fatigue/injury of a player.

The classification metric is used to learn a decision-tree, which is a coarse-to-fine hierarchical method, where at each node a question is posed which splits the data into groups. A benefit of this approach is that it can be interpretable and is multi-layered, which can act as “latent factors.”

### Bottom-Up Approach

In an embodiment of the system, a bottom-up approach to learning the decision tree is used. Various features are used in succession to discriminate between plays (e.g., first use the ball, then the player who is closest to the ball, then the defender etc.). By aligning the trajectories, there is a point of reference for trajectories relative to their current position. This permits more specific questions while remaining general (e.g., if a player is in the role of “point guard”, what is the distance from his/her teammate in the role of “shooting guard”, as well as the distance from the defender in the role of “point guard”). Using this approach avoids the need to exhaustively check all distances, which is enormous for both basketball and soccer.

### Top-Down Approach

In another embodiment of the system, a top-down approach to learning the decision tree is used. At a first step, all the plays are aligned to the set of templates. From this initial set of templates, the plays are assigned to a set of K groups (clusters), using all ball and player information, forming a Layer 1 of the decision tree. Back propagation is then used to prune out unimportant players and divide each cluster into sub-clusters (Layer 2). The approach continues until the leaves of the tree represent a dictionary of plays which are predictive of a particular task—e.g., goal-scoring (Layer 3).

### Personalization Using Latent Factor Models

In addition to raw trajectory information, in embodiments of the system, the plays in the database are also associated with game event information and context information. The game events and contexts in the database for a play may be inferred directly from the raw positional tracking data (e.g., a made or missed basket), or may be manually entered. Role information for players (can also be either inferred from the positional tracking data or entered separately. In embodiments of the system, a model for the database can then be trained by crafting features which encode game specific information based on the positional and game data and then calculating a prediction value (between 0 and 1) with respect to a classification metric (e.g., expected point value).

If there are a sufficient number of examples, the database model can be personalized for a particular player or game situation using those examples. In practice, however, a specific player or game situation may not be adequately represented by plays in the database. Thus, embodiments of the system find examples which are similar to the situation of interest-whether that be finding players who have similar characteristics or teams who play in a similar manner. A more general representation of a player and/or team is used, whereby instead of using the explicit team identity, each player or team is represented as a distribution of specific attributes. Embodiments of the system use the plays in the hash-table/playbook that were learned through the distributive clustering processes described above.

Further, while various aspects are discussed with respect to a single sport, such aspects are described are merely illustrative examples. Disclosed techniques are by no means limited to any sport in particular. For example, the present aspects can be implemented for other sports or activities, such as soccer, football, basketball, baseball, hockey, cricket, rugby, tennis, team sports, individual sports, and so forth.

FIG. 2A depicts a graphical representation of how generative AI works with sports tracking data, in accordance with techniques disclosed herein. The system receives the broadcast footage 202 of a sporting event, for example, tracking system 102 may provide organization computing system 104 with a broadcast stream of a game or event. The system then generates raw broadcast tracking information 204 and event data 206 based on a plurality of data points extracted from the broadcast footage 202, for example, tracking data system 116 may generate tracking data based on the received broadcast data. The system may then estimate the additional data points of other players not in display from the broadcast capture to determine the locations and actions of other players on the field (e.g., event data 206). For example, the broadcast video may be categorized into trackable and untrackable clips. Each of the clips may identify one or more players based on player characteristics (e.g., body pose, physical features, etc.). Tracking data system 116 may utilize the trackable and untrackable clips to reidentify players who are not within a line of sight of a camera during a given frame. In addition, tracking data system 116 may further utilize optical character recognition techniques to extract additional information (e.g. score, time, etc.). Although broadcast tracking information is depicted in FIG. 2A, it will be understood that an in-venue system (e.g., using in-venue cameras) may provide one or more video feeds. Tracking data and event data may be extracted using a broadcast feed or in-venue feed as described above with reference to FIG. 1.

Tracking data may include player and/or object position information, movement information, trends, changes, and/or the like. Event data 206 may be annotated or tagged data that is annotated or tagged by a user or via a system (e.g., play-by-play module 120). Such event data 206 may include information such as an action (e.g., a pass, a goal, a type of sports activity, etc.), an event (e.g., a time based event such as the beginning or end of a quarter or half, possession time, etc.). As also shown in FIG. 2A, a diffuser 208 (e.g., a soccer diffuser) may generate continuous (e.g., realistic) sporting event tracking and event data that algorithmically accounts for missing tracking and/or event data (e.g., due to occlusions).

A generative machine multimodal sports LLM may be trained and/or have access to the tracking data, event data, and/or diffused tracking and event data depicted in FIG. 2A. Accordingly, the multimodal sports LLM may be specifically trained using sports data and may generate outputs based on such sports data.

As discussed herein, a multimodal sports LLM may be trained using historical or simulated tracking and event data. The historical or simulated tracking and event data may be based on sporting events that are processed using the broadcast and/or in-venue steams discussed in reference to FIG. 2A. Accordingly, the historical or simulated tracking and event data may correspond to sporting events and may include player and/or object position information, movement information, trends, changes, and/or the like. Such historical or simulated tracking and event data may be stored as tagged data, untagged data, tracking or event models, mathematical representations of associated data, and/or the like.

The multimodal sports LLM may be trained to output corresponding historical or simulated event data and/or tracking data or to output generated event data and/or tracking data. Accordingly, an output of the multimodal sports LLM may be a historical play or sports action identified based on a user query. Alternatively, the output of the multimodal sports LLM may be model generated tracking and/or event data in response to the user query (e.g., for a current sporting event). As discussed herein, the output may be in response to a query which is received as an input to the multimodal sports LLM, where the multimodal sports LLM identifies parameters based on the query and generates an output based on accessing one or more databases.

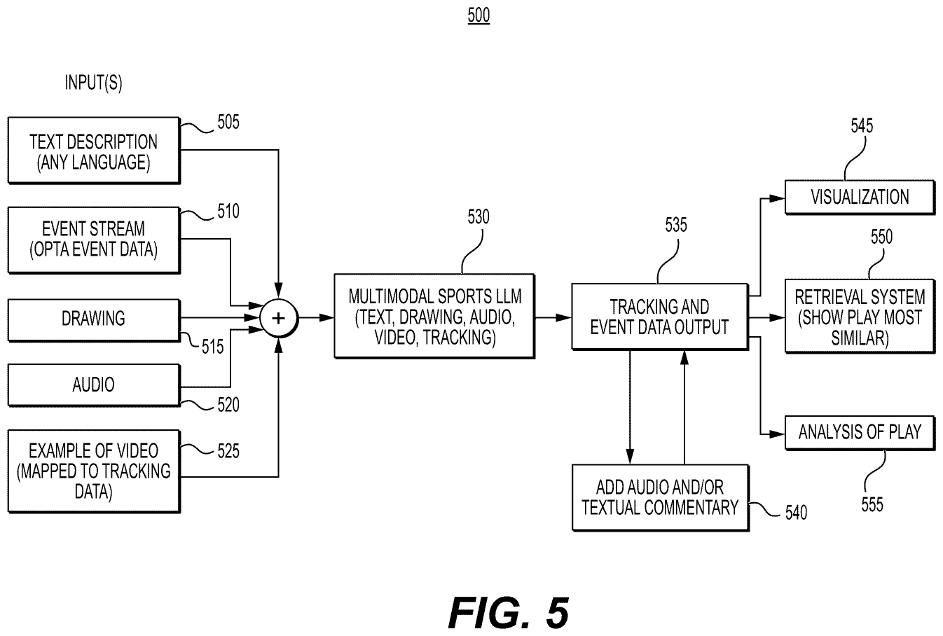

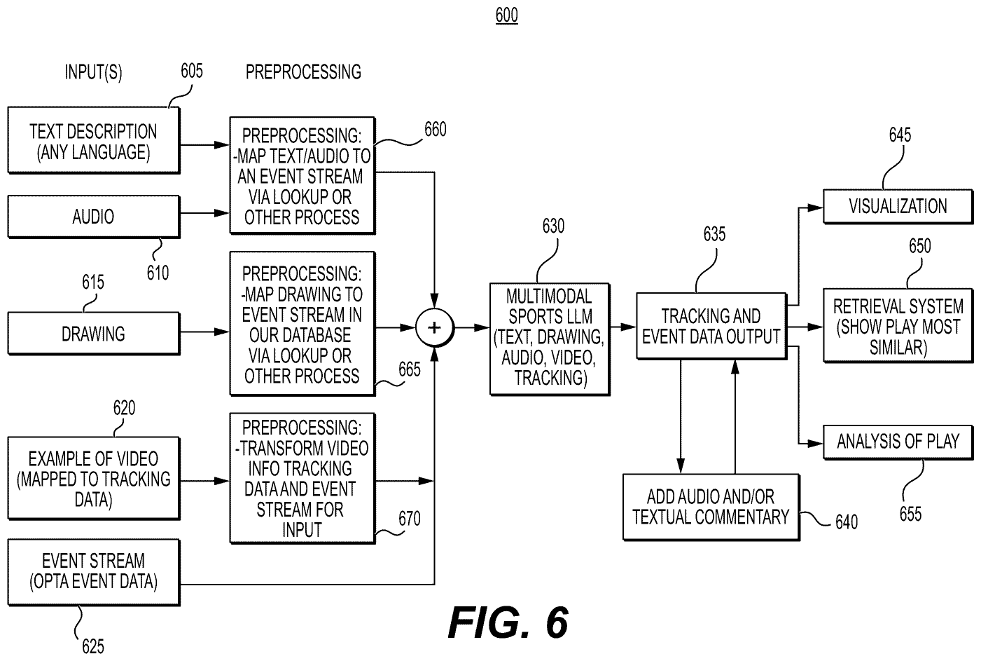

FIG. 2B depicts an example flowchart for generating tracking and/or event data, in accordance with an aspect of the disclosed subject matter. At step 210, one or more inputs by a user or system (e.g., a user query) may be received. The one or more inputs may include a description of a sporting action (e.g., a play), a question, a team or player, etc. and may be in a text format, audio format, visual format, event/tracking data format, or the like, as discussed herein (e.g., in reference to FIGS. 5 and 6). For example, client device 108 may be executing application 130 providing an interactive user interface. A user may make a selection to input a query (e.g., “show me the last goal scored between Manchester United and Liverpool”) using one or more input techniques.

At step 212, one or more metadata items related to the description may be extracted, for example, mapping module 124 may extract metadata items (e.g., contextual items) from the user input (e.g., description) to generate one or more connections and/or associations relating to a game or sporting event. The one or more metadata items may correlate aspects of the description with features that can be mapped to an event stream. An event stream may be historical or simulated tracking and/or event data determined based on a broadcast or in-venue sports stream. Accordingly, at step 212, a user input query (e.g., description) may be translated into a format that allows mapping the input query to an event stream.

For example, at step 212, mapping module 124 may use a generative model to convert the description received as a query into one or more metadata items associated with one or more sporting events. The metadata items may be specific items provided in the description (e.g., player, team, sporting event, etc.) and/or may be items identified by the generative model to be associated with the specific items provided in the description (e.g., specific plays, opponent information, types of event actions, types of tracking data, etc.). Accordingly, the generative model disclosed herein that is trained based on historical or simulated sport event information may be used to generate metadata items that meet a threshold correlation value to the description. In doing so, the generative model may exclude unrelated metadata items, allowing for faster and more efficient subsequent operations limited to the identified metadata items.

At step 214, the metadata items may be mapped to one or more event streams, as further discussed in reference to FIG. 6. The mapped event stream and/or contextual information associated with the mapped event stream may be provided to a multimodal sports LLM model. For example, after determining one or more contextual items, mapping module 124 may determine one or more connections and/or associations to the event stream based on the determined contextual items. In doing so, the mapping module 124 may translate the user input query from a first format into a second format recognizable by one or more components and/or machine learning models. The second format may include the connections and/or associations to the event stream. Accordingly, at step 214, one or more event streams corresponding to the query may be identified based on the mapping.

The one or more event streams as well as the connections and/or associations determined at step 214 may be provided to a multimodal sports LLM model, as discussed above. The multimodal sports LLM model may be trained to determine content items from the event streams.

At step 216, the multimodal sports LLM model may apply the connections and/or associations identified based on the query to the one or more event streams. Applying the connections and/or associations to the event streams may include, for example, assigning a correlation score to subsets of the event streams. For example, the multimodal sports LLM model may assign attributes to each subset of the event streams. The attributes may be based on the tracking data and/or event data corresponding to each applicable subset of the event streams. The attributes may cluster the tracking data and/or event data by the actions (e.g., play types, players, teams, actions, events, scores, passes, etc.) performed therein. The attributes may be determined by identifying the actions performed in each respective subset of the event streams. The multimodal sports LLM model may then assign a correlation score to each subset of the event streams and the connections and/or associations identified based on the query. For example, the query may call for goals scored in a given sporting match. At step 214, connections and/or associations associated with a goal being scored may be identified. These connections and/or associations may, for example, include proximity of an offensive player to a goal (e.g., based on tracking data), the movement of a ball in proximity to the goal (e.g., based on tracking data), the accordance of a scoring event (e.g., based on tracking data or excitement data), or the like. The multimodal sports LLM model may assign a high correlation score to the subset of the event streams that indicate a goal scored or attempted based on the attributes associated with each respective subset of the event streams. The correlation score may be determined based on a degree of overlap or correlation between the attributes for a given subset of event stream and the connections and/or associations identified based on the query. For example, a subset of an event stream that is assigned a goal scored attribute may have a higher correlation score in comparison to a subset of an event stream that is assigned a pass made attribute based on respective tracking and/or event data.

At step 216, the multimodal sports LLM model may identify content items corresponding to the subset of event streams that have a correlation score higher than a threshold correlation score. Continuing the example above, a subset of an event stream that has attributes associated with a goal scored may have a correlation score higher than a threshold correlation score. Accordingly, video and/or audio content associated with that subset of the event stream may be identified by the multimodal sports LLM model as content items for output. The content items may further include a description of the subset of the event stream generated by the multimodal sports LLM model to describe the actions performed in that subset of the event stream. For example, the multimodal sports LLM model may translate the video and/or audio data in the subset of the event stream into a summary or analysis of the actions performed in that subset of the event stream (e.g., based on the audio/video feed, based on broadcast information, based on associated tracking data, based on associated event data, etc.).

Accordingly, at step 216, one or more content items that relate to the one or more mapped event streams (or subsets thereof) may be output by the multimodal sports LLM. As discussed herein, the multimodal sports LLM may be trained to output actual or generated event, data, tracking data, video content, audio content, summaries, analysis, and/or other content that correlate with the event streams mapped at step 214. As discussed above, mapped event streams may provide features, criteria, and/or boundaries for the information requested via the query, in a format that allows multimodal sports LLM to output a response to the query.

At step 216, the one or more content items output by the multimodal sports LLM may include actual or generated event, data, tracking data, video content, audio content, summaries, analysis, and/or other content in response to the user query. The actual or generated event, data, tracking data, video content, audio content, summaries, analysis, and/or other content may include player and/or object position information, movement information, trends, changes, plays, event actions, and/or the like in response to the user query.

At step 218, the actual or generated content items output by the multimodal sports LLM may be provided to the user (e.g., via a user device). The output may be provided as a visual display depicting the player and/or object position information, movement information, trends, changes, summaries, analysis, and/or the like in response to the user query. For example, the player and/or object information may be provided in a video format that depicts a play corresponding to the player and/or object information. The video may correspond to the identified subset of one or more event streams that exceed the correlation threshold and may progress from the beginning to an end of the play and may include indicators representing the player and/or object information. As another example, the player and/or object information may be provided in an image format. The image may depict player and/or object information over the course of a given play.

At step 218, the actual or generated content items may be formatted in a manner or order determined by the multimodal sports LLM based on the query. For example, where multiple subsets of event streams meet the correlation threshold, the multimodal sports LLM may identify a priority order for outputting the content streams generated based on the multiple subsets of event streams. The priority order may be determined by applying weights to each of the multiple event streams (and corresponding content streams). The weights may be generated by the multimodal sports LLM based on the description of the query. The multimodal sports LLM may be trained to determine such weights based on training data that includes historical or simulated event streams, subsets of event streams, queries, weights, content streams, and/or the like. Accordingly, the multimodal sports LLM may be trained to prioritize content streams that most correlate to the query and output the content streams in an order based on such prioritization (e.g., using the weights described above).

In addition, a user may input additional inputs (e.g., text, audio, drawing, etc.) to make further refinements of the inputted description. After each additional input, the system may further extract one or more additional metadata items relating to the refinements of the description. Upon determining the one or more additional metadata items, the system may perform steps similar to steps 214 to 218 as described above. This process (e.g., step 210 through step 218) may be repeated as necessary to produce a display as requested by the user.

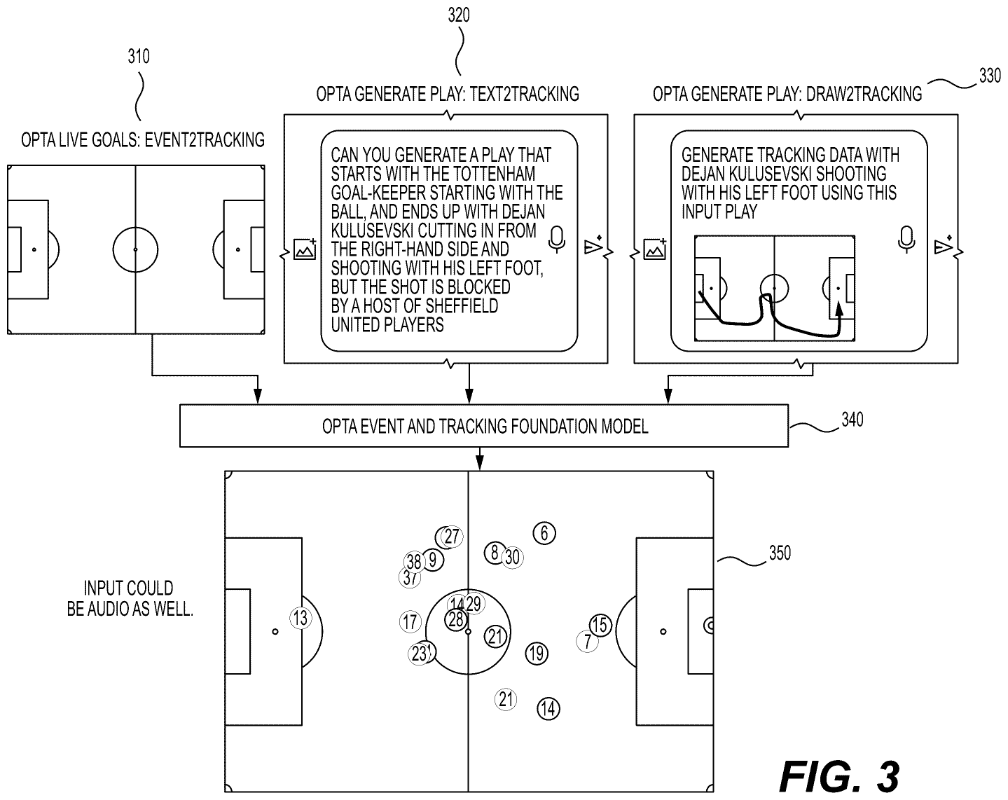

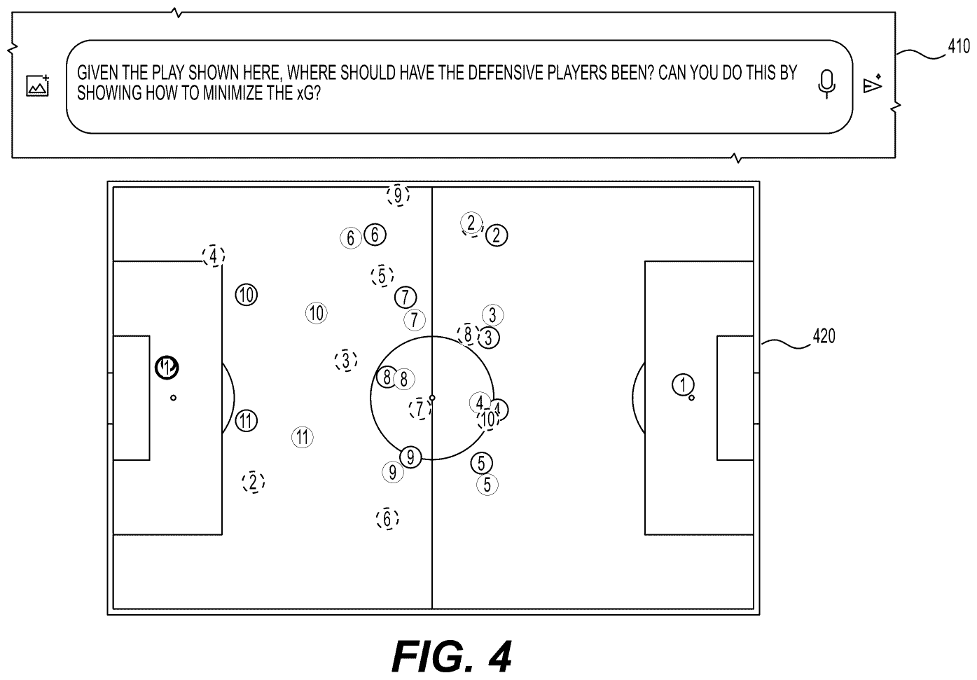

FIGS. 3 and 4 depict example user inputs scenarios for the multimodal sports LLM to generate sports tracking data, in accordance with an aspect of the disclosed subject matter. FIG. 3 depicts a user of a client device inputting a query into the system to provide (e.g., display) a generated outcome. The input as entered may be in the form of event data 310 (e.g., Event2Tracking), text data 320 (e.g., Text2Tracking), or visual data 330 (e.g., Draw2Tracking). Event data 310 may be a file or may otherwise be provided as event or tracking data (e.g., based on a historical event). Text data 320 may be a textual input which may be input by a user or may be provided as an audio input converted into a text input. Visual data 330 may be a drawing, illustration, or other visual input generated by a user. It will be understood that multiple inputs (e.g., text data 320 and visual data 330) may be included in a single input query. Upon entering one or more inputs, the system may extract one or more metadata items (e.g., keyword(s) and/or tag(s)) based on the received input, using one or more machine learning models (e.g., event and tracking foundation model 340). Once the metadata has been extracted, an output 350 may be displayed to a user. The output 350 may include one or more sports event data associated with the determined one or more keyword(s) and/or tag(s).

For example, the user input may be in the form of a question or “prompt” entered as text. The mapping module 124 may receive the user input and extract metadata (e.g., contextual information) using one or more machine learning models. Extracting metadata may include determining at least one keyword or tag associated with the description or query. Upon extracting the metadata (e.g., keyword(s) and/or tag(s)) associated with the user input, mapping module 124 may further identify event data and/or an event stream and generate connections therebetween. Mapping module 124 may utilize one or more mapping models depending on the input type used to extract and determine contextual relations.

In any scenario, the user may input a query (e.g. text and/or drawing description) describing the outcome (e.g., tracking data and/or event data) of a series of events to be provided by the multimodal sports LLM. The system (e.g., mapping module 124) may output (e.g., output 350), using the description, an outcome showing each event (e.g., in series) as entered via the user query, as if the events were to happen in a real match. The output may be simulated or historical event or tracking data and may be converted into a visual display depicting player and/or object tracking information and/or events.

FIG. 4 depicts another user example user query provided as an input. As shown, the user may input a query (e.g. audio recording and sample event) into a prompt window 410 providing a series of actions that occurred during a play. In this example, the user is requesting the system to provide an output that estimates or determines, based on the example event provided in the user query, where the defensive players should have been to minimize an attribute (e.g., likelihood of goal scored). The system then determines using data provided by the tracking data system 116 (e.g., previous behavior of players, ball movement, etc.) an output 420 depicting where each individual should have been in this scenario to stop the opposing team from scoring.

For example, a prediction engine or model, as similarly described above, may receive user inputs and associated connections (e.g., sports tracking data and/or event data) to predict an outcome. The predicted engine may predict an outcome, for a team or a series of events, using historical information for each of the players and/or teams. The historical information may provide one or more bases for determining how each player should respond to one or more movements of each player. With the scenario described above, the prediction engine may determine that some of the players were out of position relative to their role during a given play. The prediction engine may further determine that because the one or more players were out of position, the chance of scoring increased for one team and saving a goal decreased for the other team. The prediction engine may display a series of events presenting the play if each of the players would have been in position during the given play to stop the opposing team from scoring.

FIGS. 5 and 6 depicts flow diagrams of an exemplary method for using the machine-learning model to generate sports tracking data, in accordance with an aspect of the disclosed subject matter. FIG. 5 describes an exemplary method 500 for using the machine-learning model. The method 500 starts with receiving user inputs from a client device (505-525). The inputs may be in the form of text description 505, event stream 510, drawing 515, audio 520, or video 525. For example, client device 108 may execute application 130 and provide a user interface for entering one or more inputs. The user interface may include a dialogue box for inputting, via drag and drop, one or more of text, images, video clips, audio chunks, or the like. In addition, the dialogue box may include an interface object for capturing live audio and/or video from the user. Additional inputs may be received throughout the process to further refine the query.

Based on the received input(s), the system may determine contextual and intentional information to describe the sports tracking information requested. The contextual and/or intentional information may be defined at the time of the received input(s), for example defined by the user in addition to the query, and/or the contextual and/or intentional information may be inferred by the one or more models. For example, the user may input a query or a question using one or more inputs as described above, the query may include contextual and/or intentional information. The mapping module 124 may be configured to use one or more mapping models based on the input type(s) to determine contextual and intentional information from the received input(s). Each mapping model used may be trained for the specific input type, for example, a drawing interface may be mapped to a textual question, an event stream, tracking data, an image, video, or the like. The drawing mapping model may be configured to receive user input in a first format (e.g., drawings) and transform the received input into a second format (e.g., game files 126) usable by the multimodal sports LLM. The input received by the multimodal sports LLM may be configured to infer contextual and/or intentional information based on the inputted query. If the contextual and/or intentional information is received as part of the query, the multimodal sports LLM may further compare the entered contextual and/or intentional information to the inferred contextual and/or intentional information to determine the accuracy of the multimodal sports LLM. The multimodal sports LLM may use the comparison of the contextual and/or intentional information to modify the training of each additional multimodal sports LLM to generate a more accurate inference for future inputs. In addition, the system may further include a conversation layer configured to clarify or request additional information from the user to determine the contextual and/or intentional information relating to the inputted query.

Based on the contextual and intentional information, the method 500 then determines sports tracking data that matches the inputs received using the multimodal sports LLM 530. The multimodal sports LLM 530 may be part of the mapping module 124. The mapping module 124 may determine, based on the contextual and intentional information one or more connections and/or associations to one or more sports tracking data. The sports tracking data may include present and/or historical information related to individual players and/or teams. Upon the one or more sports tracking data being determined, the system may output the sports tracking data and events to the user's client device (535) (e.g., client device 108). The system may present the sports tracking data and events in one or more of audio and/or text commentary 540, visualizations 545, similar plays 550, and play analysis 555. For example, based on a user query (e.g., text or audio) to display the highlights of Manchester United, limiting the highlight to goals scored against Liverpool. The mapping module 124 may determine contextual and intentional information associated with the query and determine connections and associations to sports tracking data. Upon retrieving the sports tracking data from tracking data system 116 and/or data store 118, the system may output one or more clips of each goal scored by Manchester United against Liverpool. In addition, the user may input further modifiers or queries to refine the contextual and intentional information to further narrow the selected sports tracking data.

FIG. 6 depicts an alternative technique for outputting sports tracking and event data. As similarly described in FIG. 5, method 600 may be receive user inputs (605-625). The inputs may be in the form of text description 605, audio 610, drawing 615, video 620, or event stream 625. Based on the received inputs, a preprocessing procedure may occur. Preprocessing may include text/audio model 660, drawing model 665, or video model 670. Preprocessing may augment the received inputs by determining what sports tracking data events are being requested via the user query. For example, the system may determine contextual information associated with the query entered by the user during the preprocessing procedure. In addition to contextual information, the system may identify intentional information associated with the query, for example a question posed by the user. With this additional information, the system can better map or match sports tracking data using the multimodal sports LLM 630. As described above, the system then outputs the sports tracking data and events (635) to a user device (e.g., client device 108). The system may present the sports tracking data and events in one or more of audio and/or text commentary 640, visualizations 645, similar plays 650, and play analysis 655.

Preprocessing (660-670) may be incorporated into mapping module 124 as described in FIG. 5 or as a separate component as described herein. For example, preprocessing (660-670) may include one or more models configured to map text and/or audio inputs to an event stream (e.g., using a database lookup or other identification process). Each of the mapping models may be specific to the input type, for example, one or more for drawing inputs or one or more for video inputs. The mapping models incorporated into preprocessing (660-670) may be configured to transform the received inputs from a first format (e.g., drawings or video) into a second format (e.g., event stream or tracking stream) for use by the multimodal sports LLM.

Accordingly, during such preprocessing, text and/or audio inputs are converted into a tracking and/or event data format that may be provided to the multimodal sports LLM to more efficiently correlate with historical event and/or tracking data in order to generate output event and/or tracking data. Similarly, preprocessing (660-670) may include mapping visual data (e.g., a drawing, video data, tracking data, etc.) to an event stream (e.g., using a lookup or other identification process). Visual data may be analyzed and converted into a tracking and/or event data format that may be provided to the multimodal sports LLM to more efficiently correlate with historical event and/or tracking data in order to generate output event and/or tracking data.

As depicted in FIG. 6, event stream 625 input data may not require preprocessing as such data may already be in a format that may be provided to the multimodal sports LLM to more efficiently correlate with historical event and/or tracking data in order to generate output event and/or tracking data.

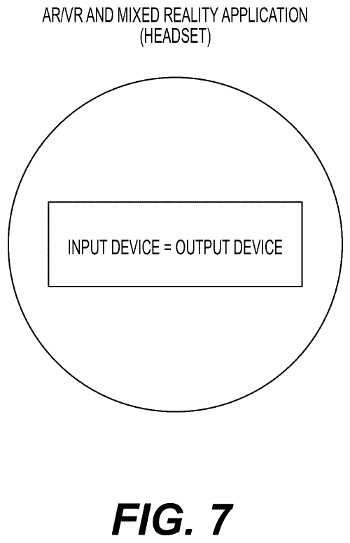

FIG. 7 depicts an example scenario of use within an AR/VR and mixed reality application (e.g., using a headset). An AR/VR and/or mixed reality device may be used to receive a user input and/or to provide the output tracking and/or event data to a user. For example, a user may use an AR/VR headset as an input device (e.g., client device 108) executing an application (e.g., application 130) displaying a dialogue box (see FIG. 4). The AR/VR headset may allow a user to input a query (e.g., text, audio, video, drawings, etc.) as described above. The system may perform the methods as described in FIGS. 5 and/or 6 above. Upon determination of one or more sports tracking data and/or event data, the system may output the sports tracking data and/or event data on a user interface of the AR/VR headset.

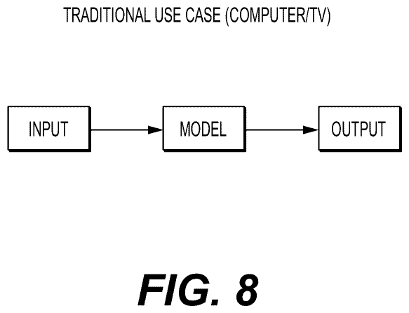

FIG. 8 depicts an example scenario of use where a user can utilize a personal computer or TV as the input/output device. For example, a user may use a personal computer or TV as an input device (e.g., client device 108) executing an application (e.g., application 130) displaying a dialogue box (see FIG. 4). The personal computer or TV may allow a user to input a query (e.g., text, audio, video, drawings, etc.) as described above. The system may perform the methods as described in FIGS. 5 and/or 6 above. Upon determination of one or more sports tracking data and/or event data, the system may output the sports tracking data and/or event data on a user interface of the personal computer or TV.

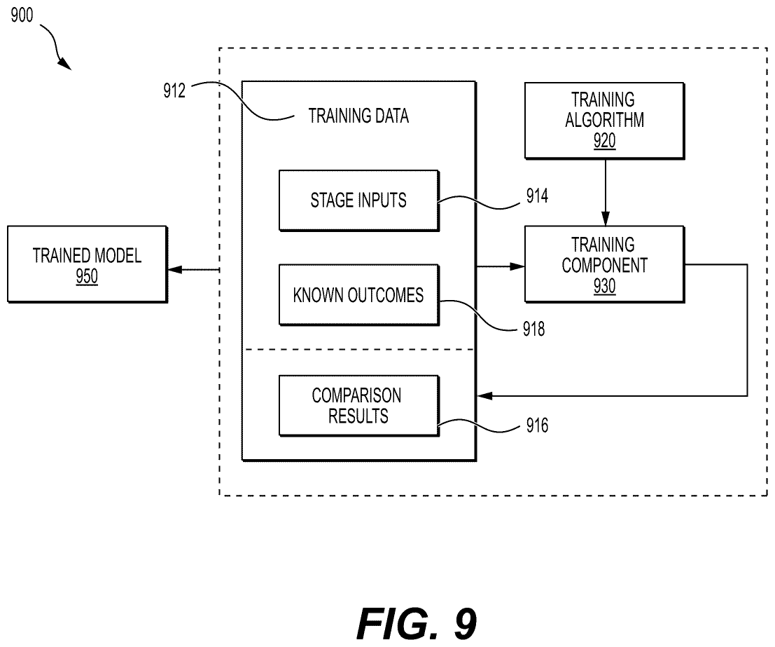

FIG. 9 depicts a flow diagram for training a machine learning model, in accordance with an aspect of the disclosed subject matter. As shown in flow diagram 900 of FIG. 9, training data 912 may include one or more of stage inputs 914 and known outcomes 918 related to a machine learning model to be trained. The stage inputs 914 may be from any applicable source including a component or set shown in the figures provided herein. The known outcomes 918 may be included for machine learning models generated based on supervised or semi-supervised training. An unsupervised machine learning model might not be trained using known outcomes 918. Known outcomes 918 may include known or desired outputs for future inputs similar to or in the same category as stage inputs 914 that do not have corresponding known outputs.

The training data 912 and a training algorithm 920 may be provided to a training component 930 that may apply the training data 912 to the training algorithm 920 to generate a trained machine learning model 950. According to an implementation, the training component 930 may be provided comparison results 916 that compare a previous output of the corresponding machine learning model to apply the previous result to re-train the machine learning model. The comparison results 916 may be used by the training component 930 to update the corresponding machine learning model. The training algorithm 920 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 900 may be a trained machine learning model 950.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

### Machine Learning for Team/Player Predictions

According to embodiments disclosed herein, a transformer neural network may receive inputs (e.g., tensor layers), where each input corresponds to a given player, team, or game. The transformer neural network may output generated predictions for one or more given players or teams based on such inputs. More specifically, the transformer neural network may output such generated predictions for a given player or team based on inputs associated with that given player or team and further based on the influence of one or more other players or teams. Accordingly, predictions provided by a transformer neural network, as discussed herein, may account for the influence of multiple players and/or teams when outputting a prediction for a given player and/or team.

The system described herein may include a machine learning system configured to generate one or more predictions. In some examples, the system may incorporate a transformer neural network, graphical neural network, a recurrent neural network, a convolutional neural network, and/or a feed forward neural network. The system may implement a series of neural network instances (e.g., feed forward network (FFN) models) connected via a transformer neural network (e.g., a graph neural network (GNN) model). Although a transformer neural network is generally discussed herein, it will be understood that any applicable GNN, or other neural network that may utilize graphical interpretations, may be used to perform the techniques discussed herein in reference to a transformer neural network.

The transformer-based neural network may include a set of linear embedding layers, a transformer encoder, and a set of fully connected layers. The set of linear embedding layers may map component tensors of received inputs into tensors with a common feature dimension. The transformer encoder may perform attention along the temporal and agent dimensions. The set of fully connected layers may map the output embeddings from a last transformer layer of the transformer encoder into tensors with requested feature dimension of each target metric.

The transformer-based neural network may be configured to receive input features through the set of linear embedding layers. The input features may be received at different resolutions and over a time-series. The input features may relate to player features, team features, and/or game features. Input features may be input into the linear embedding layers as a tuple of input tensors. For example, a tuple of three tensors may be provided where the first tensor corresponds to all players in a match, a second tensor corresponds to both teams in the match, and the third tensor corresponds to a match state.

Examining the set of linear embedding layers, the linear embedding layers may contain a linear block for each input tensor of the tuple, and each block may map an input tensor to a tensor with a common feature dimension D. The output of the linear embedding layer may be a tuple of tensors, with a common feature dimension, which can be concatenated along the temporal and agent dimension to form a single tensor.

The transformer encoder may be configured to receive the single tensor from the linear embedding layers. The transformer encoder may be configured to learn an embedding that is configured to generate predictions on multiple actions for each agent (e.g., each player and/or team). The transformer encoder may include a series of axial transformer encoder layers, where each layer alternatively applies attention along the temporal and agent dimensions. The transformer encoder may include layers that alternate between temporally applying attention to sequences of action events, and applying attention spatially across the set of players and teams at each event time-step. The transformer encoder may include axial encoder layers configured to accept a tensor from the linear layers and apply attention along the temporal dimension, then along the agent dimension.

The attention mechanism that is implemented by the transformer encoder layers may have a graphical interpretation on a dense graph where each element is a node, and the attention mask is the inverse of the adjacency matrix defining the edges between the nodes (the absence of an attention mask thus implies a fully-connected graph). In the case of the axial attention used here, with the attention mask on the temporal (row) dimension, the nodes in the graph can be arranged in a grid, and each node may be connected to all nodes in the same column, and to all previous nodes in the same row. Attention, in this case, may be message-passing where each node can accept messages describing the state of the nodes in its neighborhood, and then update its own state based on these messages. This attention scheme may mean that when making a prediction for a particular player, the model may consider (i.e. attend to): the nodes containing the previous states of the player along the time-series; and the state nodes of the other players, team and the current game state in the current time-step. It may not be necessary for the nodes to be homogeneous—beyond having the same feature dimension—and thus a node that represents a player can accept messages from a node that represents at team, or from the player's strength node. The model may therefore learn the interactions between agents, and ensure consistent predictions for each agent along the time-series. The output of the transformer encoder layers may be a tensor (e.g., an output embedding).

The final layers of the transformer-based neural network may be the fully connected layers. These layers may map the output embedding of the final transformer layer of the transformer encoder to the feature dimension of each target metric. The final layers may output a target tuple that contains tensors for each of a set of modeled actions for each player and/or team. For example, the modeled action may be an empirical estimate of distributions for sport statistics such as number of shots taken, number of goals, number of passes, etc.

The training of the transformer-based neural network may include choosing a corresponding loss function for the distribution assumption of each output target. For example, the loss function may be the Poisson negative log-likelihood for a Poisson distribution, binary cross entropy for a Bernouilli distribution, etc. The losses may be computed during training according to the ground truth value for each target in the training set, and the loss values may be summed, and the model weights may be updated from the total loss using an optimizer. The learning rate may have been adjusted on a schedule with cosine annealing, without warm restarts.

### Sports Machine Learning

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., a weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competition landscape. A sports machine learning model may be trained to adjust one or more weights, layers, nodes, biases, and/or synapses to associate certain sports statistics in view of a competition landscape. For example, a win indicator for a given team may automatically correlated with a loss indicator for an opposing team. As another example, a score static may be considered a positive attribution for a scoring team and a negative attribution for a team being scored upon. As another example, a given score may be ranked against one or more scores based on a relative position of the score in comparison to the one or more other scores.

A sports machine learning model may be trained based on sports tracking and/or event data, as discussed herein. Such data may include player and/or object position information, movement information, trends, and changes. For example, a sports machine learning model may be trained by modifying one or more weights, layers, nodes, biases, and/or synapses to associate given positions in reference to the playing surface of venue and/or in reference to none or more agents. As another example, a sports machine learning model may be trained by modifying one or more weights, layers, nodes, biases, and/or synapses to associate given movement or trends in reference to the playing surface of venue and/or in reference to none or more agents. As another example, a sports machine learning model may be trained by modifying one or more weights, layers, nodes, biases, and/or synapses to associate sporting events with corresponding time boundaries, teams, players, coaches, officials, and environmental data associated with a location of corresponding sporting events.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine learning model may be trained in view sports targets, play outcomes, player positions, and/or the like associated with a given sport (e.g., soccer, American football, basketball, baseball, tennis, golf, rugby, hockey, a team sport, an individual sport, etc.). For example, a soccer based sports machine learning model may be trained to correlate or otherwise associate player position information in reference to a soccer pitch. The soccer based sports machine learning model may further be trained to correlate or otherwise associate sports data in reference to a number of players and sports targets specific to soccer.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data.

### Machine Learning Models.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), deep learning, graphical neural network (GNN), and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity.

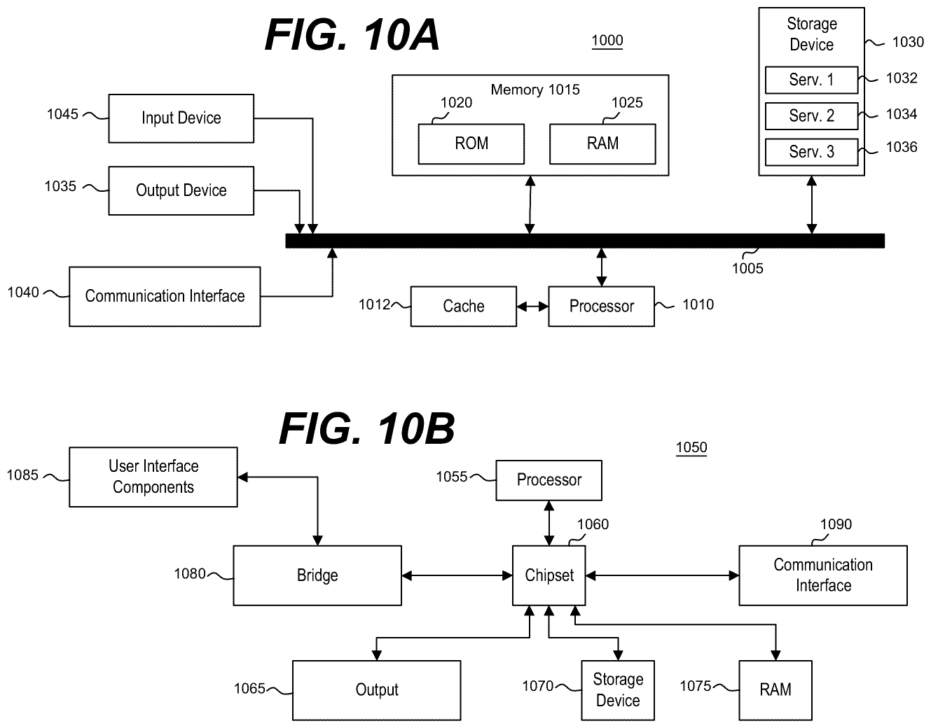

FIG. 10A illustrates an architecture of computing system 1000, according to example embodiments. System 1000 may be representative of at least a portion of organization computing system 104. One or more components of system 1000 may be in electrical communication with each other using a bus 1005. System 1000 may include a processing unit (CPU or processor) 1010 and a system bus 1005 that couples various system components including the system memory 1015, such as read only memory (ROM) 1020 and random access memory (RAM) 1025, to processor 1010. System 1000 may include a cache of high-speed memory connected directly with, in close proximity to, or integrated as part of processor 1010. System 1000 may copy data from memory 1015 and/or storage device 1030 to cache 1012 for quick access by processor 1010. In this way, cache 1012 may provide a performance boost that avoids processor 1010 delays while waiting for data. These and other modules may control or be configured to control processor 1010 to perform various actions. Other system memory 1015 may be available for use as well. Memory 1015 may include multiple different types of memory with different performance characteristics. Processor 1010 may include any general purpose processor and a hardware module or software module, such as service 1 1032, service 2 1034, and service 3 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction with the computing system 1000, an input device 1045 may represent any number of input mechanisms, such as a microphone for speech, a touch-sensitive screen for gesture or graphical input, keyboard, mouse, motion input, speech and so forth. An output device 1035 (e.g., display) may also be one or more of a number of output mechanisms known to those of skill in the art. In some instances, multimodal systems may enable a user to provide multiple types of input to communicate with computing system 1000. Communications interface 1040 may generally govern and manage the user input and system output. There is no restriction on operating on any particular hardware arrangement and therefore the basic features here may easily be substituted for improved hardware or firmware arrangements as they are developed.

Storage device 1030 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 1025, read only memory (ROM) 1020, and hybrids thereof.

Storage device 1030 may include services 1032, 1034, and 1036 for controlling the processor 1010. Other hardware or software modules are contemplated. Storage device 1030 may be connected to system bus 1005. In one aspect, a hardware module that performs a particular function may include the software component stored in a computer-readable medium in connection with the necessary hardware components, such as processor 1010, bus 1005, output device 1035, and so forth, to carry out the function.

FIG. 10B illustrates a computer system 1050 having a chipset architecture that may represent at least a portion of organization computing system 104. Computer system 1050 may be an example of computer hardware, software, and firmware that may be used to implement the disclosed technology. System 1050 may include a processor 1055, representative of any number of physically and/or logically distinct resources capable of executing software, firmware, and hardware configured to perform identified computations. Processor 1055 may communicate with a chipset 1060 that may control input to and output from processor 1055. In this example, chipset 1060 outputs information to output 1065, such as a display, and may read and write information to storage device 1070, which may include magnetic media, and solid-state media, for example. Chipset 1060 may also read data from and write data to RAM 1075. A bridge 1080 for interfacing with a variety of user interface components 1085 may be provided for interfacing with chipset 1060. Such user interface components 1085 may include a keyboard, a microphone, touch detection and processing circuitry, a pointing device, such as a mouse, and so on. In general, inputs to system 1050 may come from any of a variety of sources, machine generated and/or human generated.

Chipset 1060 may also interface with one or more communication interfaces 1090 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 1055 analyzing data stored in storage device 1070 or RAM 1075. Further, the machine may receive inputs from a user through user interface components 1085 and execute appropriate functions, such as browsing functions by interpreting these inputs using processor 1055.

It may be appreciated that example systems 1000 and 1050 may have more than one processor 1010 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A method for generating sports tracking data using multimodal generative models, the method comprising:
receiving, by a computing system, one or more inputs by a user, wherein the one or more inputs comprise at least a description;
extracting, by the computing system, one or more metadata items relating to the description;
mapping, by the computing system, the one or more metadata items to at least one or more event streams;
receiving, by the computing system, one or more content items relating to the at least one or more event streams, wherein the one or more content items relating to the at least one or more event streams is output by a multimodal sports learning language model (LLM); and
transmitting, by the computing system, the one or more content items to a user device for display.

2. The method of claim 1, wherein the one or more inputs by the user comprise at least one of text, audio, drawing, or video.

3. The method of claim 1, wherein extracting, by the computing system, one or more metadata items relating to the description further comprises: determining at least one keyword or tag associated with the description.

4. The method of claim 1, wherein mapping, by the computing system, the one or more metadata items to at least one or more event streams further comprises:
determining at least one keyword or tag associated with the one or more metadata items relating to the at least one or more event streams; and
matching the at least one keyword or tag associated with the description to the determined at least one keyword or tag relating to the at least one or more event streams.

5. The method of claim 1, following mapping the one or more metadata items further comprises:
retrieving, by the computing system, the one or more content items relating to a subset of the at least one or more event streams.

6. The method of claim 1, the method further comprises:
receiving, by the computing system, additional inputs by the user, wherein the additional inputs comprise further refinements of the description.

7. The method of claim 6, the method further comprises:
extracting, by the computing system, one or more additional metadata items relating to the refinements of the description;
mapping, by the computing system, the one or more additional metadata items to at least one or more event streams;
receiving, by the computing system, one or more content items relating to the at least one or more event streams, wherein the one or more content items relating to the at least one or more event streams is output by a multimodal sports learning language model (LLM); and
transmitting, by the computing system, the one or more content items to a user device for display.

8. A system for generating sports tracking data using multimodal generative models, the system comprising:
a memory storing instructions:
a generative machine learning model trained to generate sports tracking data;
a processor operatively connected to the memory and configured to execute instructions to perform:
receive one or more inputs by a user, wherein the one or more inputs comprise at least a description;
extract one or more metadata items relating to the description;
map the one or more metadata items to at least one or more event streams;
receive one or more content items relating to the at least one or more event streams, wherein the one or more content items relating to the at least one or more event streams is outputted by a multimodal sports learning language model (LLM); and
transmit the one or more content items to a user device for display.

9. The system of claim 8, wherein the one or more inputs by the user comprise at least one of text, audio, drawing, or video.

10. The system of claim 8, wherein extracting one or more metadata items relating to the description further comprises: determining at least one keyword or tag associated with the description.

11. The system of claim 8, wherein mapping the one or more metadata items to at least one or more event streams further comprises:
determining at least one keyword or tag associated with the one or more metadata items relating to the at least one or more event streams; and
matching the at least one keyword or tag associated with the description to the determined at least one keyword or tag relating to the at least one or more event streams.

12. The system of claim 8, following mapping the one or more metadata items further comprises:
retrieving the one or more content items relating to a subset of the at least one or more event streams.

13. The system of claim 8, the system further comprises:
receiving additional inputs by the user, wherein the additional inputs comprise further refinements of the description.

14. The system of claim 13, the system further comprises:
extracting, by the computing system, one or more additional metadata items relating to the refinements of the description;
mapping the one or more additional metadata items to at least one or more event streams;
receiving one or more content items relating to the at least one or more event streams, wherein the one or more content items relating to the at least one or more event streams is output by a multimodal sports learning language model (LLM); and
transmitting the one or more content items to a user device for display.

15. A non-transitory computer readable medium configured to store processor-readable instructions, wherein when executed by a processor, the instructions perform operations comprising:
receiving, by a client device, one or more user inputs, wherein the one or more user inputs comprise at least a description;
extracting one or more metadata items relating to the description;
mapping the one or more metadata items to at least one or more event streams;
receiving one or more content items relating to the at least one or more event streams, wherein the one or more content items relating to the at least one or more event streams is outputted by a multimodal sports learning language model (LLM); and
transmitting the one or more content items to a user device for display.

16. The non-transitory computer readable medium of claim 15, wherein the one or more user inputs comprise at least one of text, audio, drawings, or video.

17. The non-transitory computer readable medium of claim 15, wherein extracting one or more metadata items relating to the description further comprises: determining at least one keyword or tag associated with the description.

18. The non-transitory computer readable medium of claim 15, wherein mapping the one or more metadata items to at least one or more event streams further comprises:
determining at least one keyword or tag associated with the one or more metadata items relating to the at least one or more event streams; and
matching the at least one keyword or tag associated with the description to the determined at least one keyword or tag relating to the at least one or more event streams.

19. The non-transitory computer readable medium of claim 15, following mapping the one or more metadata items further comprises:
retrieving the one or more content items relating to a subset of the at least one or more event streams.

20. The non-transitory computer readable medium of claim 15, the instructions perform operations further comprises:
receiving, by the client device, additional inputs by the user, wherein the additional inputs comprise further refinements of the description;
extracting one or more additional metadata items relating to the refinements of the description;
mapping the one or more additional metadata items to at least one or more event streams;
receiving one or more content items relating to the at least one or more event streams, wherein the one or more content items relating to the at least one or more event streams is output by a multimodal sports learning language model (LLM); and
transmitting the one or more content items to a user device for display.
